(19) United States
(12) Patent Application Publication
(10) Pub. No.: US 2007/0229781 A1
(43) Pub. Date: Oct. 4, 2007

(54) Projector and supporting structure thereof

(75) Inventors: Chun-Hsiung Yin, Yungkang (TW); Yi-Yen Lin, Banciao City (TW); Jiung-Cheng Pan, Tainan City (TW); Yi-Ting Hsu, Jhonghe City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/729,878

(22) Filed: Mar. 30, 2007

(30) Foreign Application Priority Data
Mar. 31, 2006 (TW) 095111679

(51) Int. Cl. G03B 21/14

(52) U.S. Cl. 353/119

(57) ABSTRACT

A projector and a supporting structure thereof are provided. The projector includes a main body and a supporting structure. The supporting structure is disposed at the main body. The supporting structure includes a sliding element and an elastic element. The sliding element is supported on a plane and can move backward and forward with respect to the main body. The elastic element has a first end and a second end. The first end is coupled to the sliding element, and the second end is coupled to the main body. The elastic element generates a substantially constant elastic force when the elastic element is deformed. As the sliding element moves with respect to the main body, the elastic force balances against the gravity force of the main body, such that the elevational angle of the main body with respect to the plane is changed.

This application claims the benefit of Taiwan application Serial No. 095111679, filed Mar. 31, 2006, the subject matter of which is incorporated herein by reference.

### BACKGROUND OF THE INVENTION

1. Field of the Invention

The invention relates in general to a projector and a supporting structure, and more particularly to a projector and a supporting structure thereof capable of adjusting the elevational angle and the horizon of the main body with respect to the desk.

2. Description of the Related Art

Projectors have now been widely used in conference room, laboratory and families. It is a common experience to projector users that the frame may be inclined, too high or too low when projected on a screen. To solve this problem, the user has to adjust the horizon of the projector to avoid inclination and adjust the elevational angle of the projector with respect to the desk to avoid the frame being too high or too low.

Referring to FIG. 1A, a perspective of a conventional projector is shown. The projector 100 includes the feet 103a and the feet 103b. The user has to adjust the extended length of the feet 103a and 103b so as to adjust the elevational angle of the projector 100 with respect to the desk and adjust the relative length between the feet 103a and 103b so as to adjust the horizon of the projector 100. In order to release the feet 103a and 103b, the user has to sequentially or simultaneously press the keys 101a and 101b and hold the projector 100 by two hands for the feet 103a and 103b to come out of the main body. Meanwhile, the lengths of the feet 103a and 103b is adjustable. However, in the course of adjustment, the user has to hold the projector 100 by two hands all the time, which is very demanding and makes it difficult to adjust the lengths of the feet 103a and 103b. The user normally has to spend quite a while to complete the adjustment of the elevational angle and the horizon of the projector 100a with respect to the desk.

Referring to FIG. 1B, another perspective of a conventional projector is shown. The adjustment of the lengths of the feet 203a and 203b of the projector 200 is done via screws. The user may sequentially or simultaneously rotate the nuts 201a and 201b to extend or shorten the lengths of the feet 203a and 203b. As the size of the nuts 201a and 201b is huge and the rotation of the nuts 201a and 201b is slow, the user normally has to spend quite a while to complete the adjustment of the elevational angle and the horizon of the projector 200 with respect to the desk.

Apart from the projector, various devices or articles with an adjustable supporting structure also have the same problem. Therefore, how to develop a supporting structure which is easy to function and small in size has become an imminent issue to be resolved.

### SUMMARY OF THE INVENTION

The invention is directed to a projector and a supporting structure thereof. As the deformation of an elastic element results in a substantially constant elastic force, the user can easily and quickly adjust the supporting structure to change the elevational angle and the horizon of the main body.

According to a first aspect of the present invention, a projector is provided. The projector includes a main body and a supporting structure. The supporting structure is disposed at the main body. The supporting structure includes a sliding element and an elastic element. The sliding element is supported on a plane and can move backward and forward with respect to the main body. The elastic element has a first end and a second end. The first end is coupled to the sliding element, and the second end is coupled to the main body. The elastic element generates a substantially constant elastic force when the elastic element is deformed. As the sliding element moves with respect to the main body, the elastic force balances against the gravity force of the main body, such that the elevational angle of the main body with respect to the plane is changed.

According to a second aspect of the present invention, a supporting structure is provided. The supporting structure is used for supporting a device having a main body. The supporting structure includes a sliding element, an elastic element and a fixing element. The sliding element is supported on a plane and can move backward and forward with respect to the main body. The elastic element has a first end and a second end. The first end is coupled to the sliding element, and the second end is coupled to the main body. The elastic element generates a substantially constant elastic force when the elastic element is deformed. The fixing element is fixed on the main body, for clipping the second end of the elastic element. As the sliding element moves with respect to the main body, the elastic force balances against the gravity force of the main body, such that the elevational angle of the main body with respect to the plane is changed.

The invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a perspective of a conventional projector;

FIG. 1B (Prior Art) is another perspective of a conventional projector;

FIG. 2A is a perspective of a projector according to a first embodiment of the invention;

FIG. 2B is an enlarged diagram of a supporting structure of FIG. 1;

FIG. 2C is an elastic force vs. deformation curve of an elastic element;

FIG. 2D is a perspective showing the supporting structure of the projector is at the lowest height;

FIG. 3 is a perspective of a projector according to a second embodiment of the invention;

FIG. 4 is a side view of a supporting structure of FIG. 3.

### DETAILED DESCRIPTION OF THE INVENTION

### First Embodiment

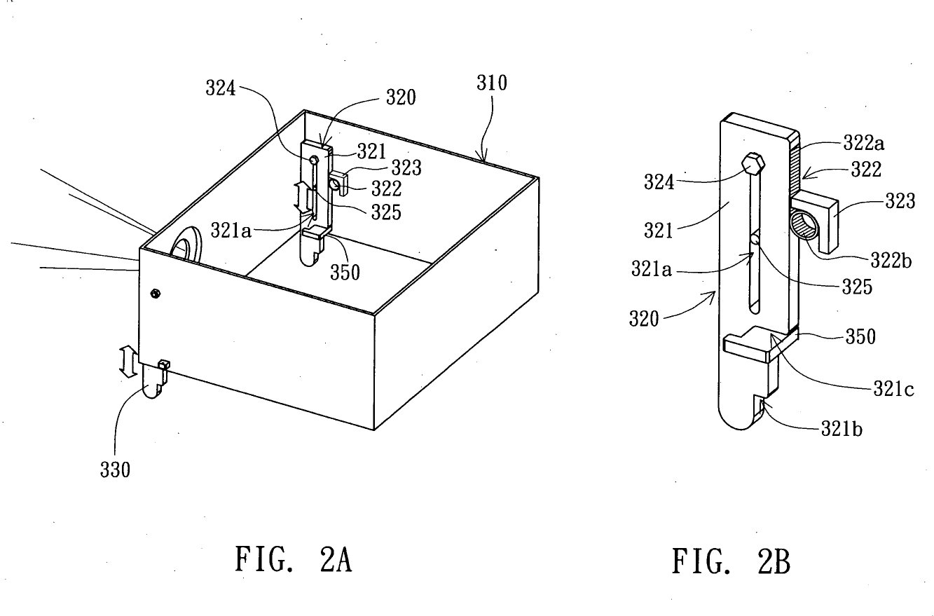

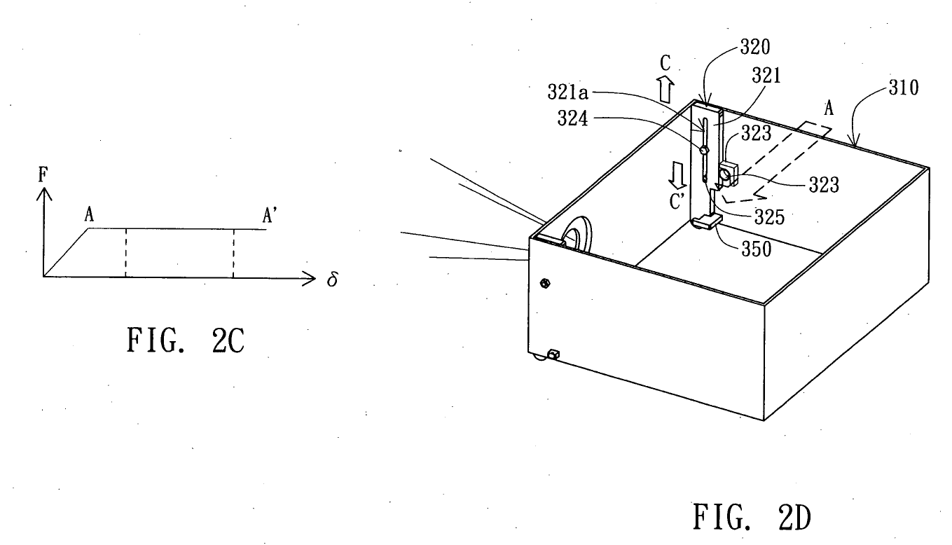

Referring to FIG. 2A, a perspective of a projector according to a first embodiment of the invention is shown. The projector 300 includes a main body 310 and at least a supporting structure. In the present embodiment of the invention, the supporting structure is exemplified by a supporting structure 320 and a supporting structure 330. The supporting structure 320 is disposed on an inner surface of a sidewall of the main body 310 and projected from the bottom of the main body 310. The supporting structure 330 is disposed on an inner surface of the other sidewall of the main body 310 and projected from the bottom of the main body 310. The two supporting structures 320 and 330 are respectively disposed at two opposite sides of the main body 310. The user can adjust the elevational angle and the horizon of the main body 310 by adjusting the lengths of the supporting structures 320 and 330. Despite the projector 300 of the present embodiment of the invention is exemplified by two adjustable supporting structures 320 and 330, however, the number of the supporting structures is not for limiting the scope of technology of the invention. As the supporting structures 320 and 330 have the same structure and elements, the following elaboration is exemplified by the supporting structure 320 only.

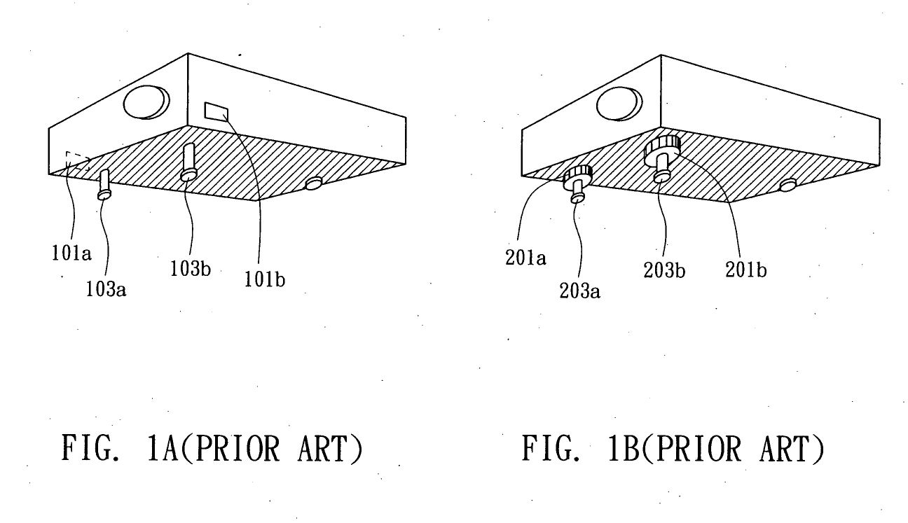

Referring to FIG. 2B, an enlarged diagram of a supporting structure of FIG. 1 is shown. The supporting structure 320 includes a sliding element 321 and an elastic element 322. The sliding element 321 is supported on a plane and can move backward and forward with respect to the main body 310. The elastic element 322 has a first end 322a and a second end 322b. The first end 322a is coupled to the sliding element 321, and the second end 322b is coupled to the main body 310. The elastic element 322 generates a substantially constant elastic force when the elastic element is deformed. As the sliding element 321 moves with respect to the main body 310, the elastic force balances against the gravity force of the main body 310, such that the elevational angle of the main body 310 with respect to the plane is changed.

Referring to FIG. 2C, an elastic force vs deformation curve of an elastic element is shown. The elastic element 322 generates a substantially constant elastic force when the elastic element is deformed. In FIG. 2C, the vertical axis denotes the elastic force F of the elastic element, and the horizontal axis denotes the deformation δ of the elastic element. After the elastic element 322 is deformed over a certain deformation δ (such as point A in FIG. 2C), the elastic element 322 will generate a substantially constant elastic force F (such as A-A′ segment in FIG. 2C). That is, regardless of the dimension of the deformation δ of the elastic element 322, the elastic element 322 provides an elastic force F which is substantially constant to balance against the gravity of the main body 310.

As indicated in FIG. 2A, the supporting structure 320 further includes a fixing element 323. The fixing element 323 is fixed on the main body 310 for clipping the second end 322b of the elastic element 322. The sliding element 321 is further retained between the fixing element 323 and the main body 310 to avoid the sliding element 321 coming off. The fixing element 323 is detachably disposed on the main body 310; or, the fixing element 323 and the main body 310 can be integrally formed in one piece. The disposition and the shape of the fixing element 323 are not for limiting the scope of technology of the invention.

As each projector may weigh differently, the elastic element of the projector may not be able to provide sufficient elastic force to balance against the gravity of the projector. Therefore, the supporting structure 320 further includes an assistant positioning element for providing a friction force to the sliding element 321 for enabling the friction force and the elastic force to balance against the gravity force of the main body 310. In the present embodiment of the invention, it is preferred that the sliding element 321 has a sliding slot 321a, and the assistant positioning element is a screw 324. After one wind of the screw 324 penetrates through the sliding slot 321a, the end of the screw 324 is coupled to the main body 310, and the other end of the screw 324 retains the sliding element 321. By rotating the screw 324, the user can enhance the friction force to compensate for the would-be insufficient elastic force provided by the elastic element 322.

Preferably, the supporting structure 320 further includes a guiding bump 325. The guiding bump 325 is disposed on the main body 310 and penetrates through the sliding slot 321a. As the screw 324 and the guiding bump 325 are coupled to the sliding slot 321a, the sliding element 321 can move foreword and backward with respect to the main body 310 along the route between screw 324 and the guiding bump 325. The route between the screw 324 and the guiding bump 325 is substantially perpendicular to the plane, such that the sliding element 321 can move upward and downward with respect to the main body 310 along the route between the screw 324 and the guiding bump 325, and that the elevational angle of the main body 310 with respect to the plane can be changed.

Besides, the projector 300 further includes a limiting element 350. The limiting element 350 is used for limiting the range of downward movement of the sliding element 321. The sliding element 321 has a first gap 321b and a second gap 321c. The limiting element 350 can be disposed under the first gap 321b or the second gap 321c for limiting the range of downward movement of the sliding element 321.

The way of adjusting the elevational angle and the horizon of a projector 300 by a supporting structure 320 is elaborated below. Referring to FIG. 2D, a perspective showing the supporting structure of the projector is at the lowest height is shown. The deformation of the elastic element 322 results in a downward elastic force on the sliding element 321. The limiting element 350 is disposed under the first gap 321b for limiting the downward movement of the sliding element 321 such that the sliding element 321 is fixed at the position as indicated in FIG. 2D. When the user presses the limiting element 350 in direction A, the first gap 321b of the sliding element 321 is not limited by the limiting element 350, and the limiting element 350 is positioned under the second gap 321c as indicated in FIG. 2A. Meanwhile, if the user holds and moves the main body 310 upward in direction C as indicated in FIG. 2D, or lightly applies a downward force to the main body 310 of the projector 300, then the projector 300 will move downward in a direction C′ due to the gravity of the projector 300 as indicated in FIG. 2D, and the sliding element 321 will move with respect to the main body 310 such that the elevational angle of the main body 310 with respect to a plane is changed. Despite the user releases his/her hands and no more holds the projector 300, the gravity of the projector 300 still enables the projector 310 to remain at a certain height via the elastic element 322. Meanwhile, the limiting element 350 is positioned under the second gap 321c to limit the range of downward movement of the sliding element 321, such that the sliding element 321 will not completely come off the main body 310.

When the user would like to collect the supporting structures 320 and 330, the user only need to press the main body 310 such that the first gap 321b of the sliding element 321 is engaged with the limiting element 350. As such, the supporting structures 320 and 330 are collected.

### Second Embodiment

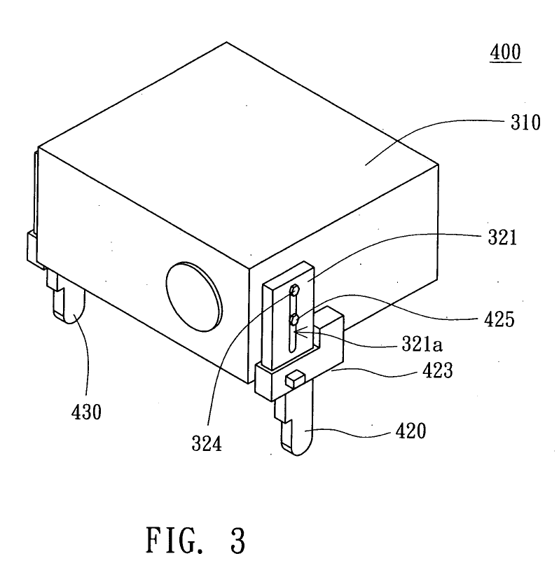

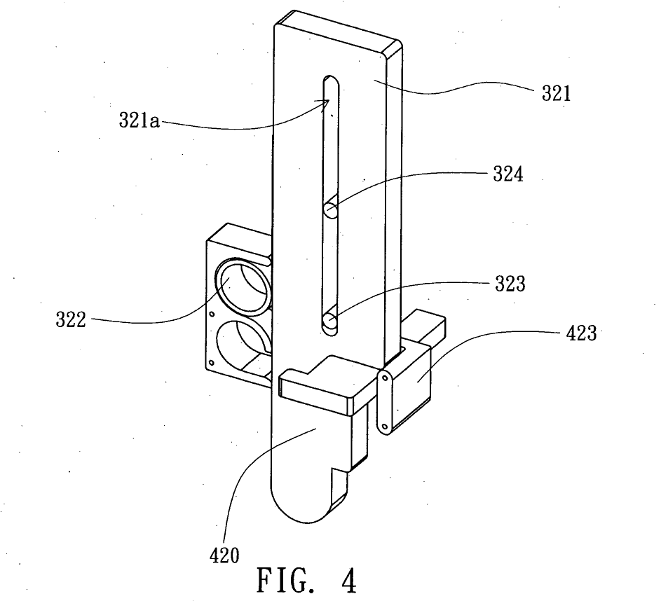

Referring to both FIG. 3 and FIG. 4. FIG. 3 is a perspective of a projector according to a second embodiment of the invention. FIG. 4 is a side view of a supporting structure of FIG. 3. The projector 400 of the present embodiment of the invention differs with the projector 300 of the first embodiment in the fixing element 423 and the guiding bump 425 and the disposition of the supporting structures 420 and 430. As for other similarities, the same reference numbers are used and are not repeated here. As the supporting structure 420 and the supporting structure 430 have the same structure, the following elaboration is exemplified by the supporting structure 420 only.

The supporting structure 420 is disposed on an outer surface of a sidewall of the main body 310. The fixing element 423 retains the sliding element 321 and the elastic element 322 by enveloping the sliding element 321 as indicated in FIG. 4. Moreover, the guiding bump 425 is a screw inserted into a sliding slot 321a and fixed on the main body 310, such that the sliding element 321 moves upward and downward with respect to the main body 310 along the route between the assistant positioning element 324 and the guiding bump 425, and that the elevational angle of the main body 310 with respect to the plane is changed. By doing so, the supporting structure. 420 and 430 is quickly adjusted. The user can further dispose or replace the supporting structure 420 and the supporting structure 430 on the projector 400.

In the above two embodiments, the supporting structure is used in a projector. However, the supporting structure of the invention can also be used in various devices or articles in addition to the projector. The supporting structure of the invention can be used in any devices or articles with height or angle adjusting functions and are still within the scope of technology of the invention.

Besides, in the above two embodiments, the supporting structure is disposed on the inner wall of the main body. However the supporting structure can be disposed on the outer wall of the main body and are still within the scope of technology of the invention.

A projector and a supporting structure thereof are disclosed in the above embodiments of the invention. As the deformation of an elastic element results in a substantially constant elastic force, the user can easily and quickly adjust the supporting structure to change the elevational angle and the horizon of the main body.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projector, comprising:
a main body; and
a supporting structure, disposed at the main body, comprising:
a sliding element, supported on a plane, capable of moving backward and forward with respect to the main body; and
an elastic element having a first end and a second end, wherein the first end is coupled to the sliding element, the second end is coupled to the main body, the elastic element generates a substantially constant elastic force when the elastic element is deformed;
as the sliding element moves with respect to the main body, the elevational angle of the main body with respect to the plane is changed.

2. The projector according to claim 1, wherein the projector comprises two supporting structures respectively disposed on two opposite sides of the main body for adjusting the elevational angle and the horizon of the main body.

3. The projector according to claim 1, wherein the supporting structure further comprises:
a fixing element fixed on the main body for clipping the second end of the elastic element.

4. The projector according to claim 3, wherein the sliding element is further retained between the fixing element and the main body to avoid the sliding element coming off.

5. The projector according to claim 3, wherein the fixing element is detachably disposed on the main body.

6. The projector according to claim 1, wherein the supporting structure further comprises:
an assistant positioning element used for providing a friction force to the sliding element, such that the friction force and the elastic force balance against the gravity force of the main body.

7. The projector according to claim 6, wherein the sliding element has a sliding slot, the assistant positioning element is a screw, one end of the screw penetrates through the sliding slot to be coupled to the main body, and the other end of the screw retains the sliding element to provide the friction force.

8. The projector according to claim 7, wherein the supporting structure further comprises:
a guiding bump disposed on the main body and penetrating through the sliding slot, wherein the screw and the guiding bump are coupled to the sliding slot, such that the sliding element moves backward and forward with respect to the main body along a route between the screw and the guiding bump.

9. The projector according to claim 8, wherein the route between the screw and the guiding bump is substantially perpendicular to the plane, such that the sliding element moves upward and downward with respect to the main body along the route between the screw and the guiding bump, and that the elevational angle of the main body with respect to the plane is changed.

10. The projector according to claim 1, further comprising:
a limiting element for limiting the range of downward movement of the sliding element.

11. The projector according to claim 10, wherein the sliding element has a first gap and a second gap, the limiting element can be moved to the underneath of the first gap or the second gap with respect to the sliding element for limiting the range of downward movement of the sliding element.

12. A supporting structure used for supporting a device having a main body, wherein the supporting structure comprises:
a sliding element supported on a plane and capable of moving backward and forward with respect to the main body;
an elastic element having a first end and a second end, wherein the first end is coupled to the sliding element, the second end is coupled to the main body, and the elastic element generates a substantially constant elastic force when the elastic element is deformed; and
a fixing element fixed on the main body for clipping the second end of the elastic element;
as the sliding element moves with respect to the main body, the elastic force balances against the gravity force of the main body, such that the elevational angle of the main body with respect to the plane is changed.

13. The supporting structure according to claim 12, wherein the sliding element is further retained between the fixing element and the main body to avoid the sliding element coming off.

14. The supporting structure according to claim 12, wherein the fixing element is detachably disposed on the main body.

15. The supporting structure according to claim 12, further comprising:
an assistant positioning element used for providing a friction force to the sliding element, such that the friction force and the elastic force balance against the gravity force of the main body.

16. The supporting structure according to claim 15, wherein the sliding element has a sliding slot, the assistant positioning element is a screw, one end of the screw penetrates through the sliding slot to be coupled to the main body, and the other end of the screw retains the sliding element to provide the friction force.

17. The supporting structure according to claim 16, wherein the supporting structure further comprises:
a guiding bump disposed on the main body and penetrating through the sliding slot, wherein the screw and the guiding bump are coupled to the sliding slot, such that the sliding element moves backward and forward with respect to the main body along the route between the screw and the guiding bump.

18. The supporting structure according to claim 17, wherein the route between the screw and the guiding bump is substantially perpendicular to the plane, such that the sliding element moves upward and downward with respect to the main body along the route between the screw and the guiding bump, and that the elevational angle of the main body with respect to the plane is changed.

19. The supporting structure according to claim 12, wherein the device comprises a limiting element for limiting the range of downward movement of the sliding element.

20. The supporting structure according to claim 19, wherein the sliding element has a first gap and a second gap, the limiting element can be moved to the underneath of the first gap or the second gap with respect to the sliding element for limiting the range of downward movement of the sliding element.
